(19) United States
(12) Patent Application Publication
(10) Pub. No.: US 2012/0048945 A1
(43) Pub. Date: Mar. 1, 2012

(54) INFORMATION CARRIER, VEHICLE WITH INFORMATION CARRIER, AS WELL AS SYSTEM FOR ASSISTING EMERGENCY SERVICES IN RESCUING OCCUPANTS FROM A VEHICLE INVOLVED IN AN ACCIDENT

(75) Inventor: Dino DEMMA, Ruesselsheim (DE)

(73) Assignee: GM GLOBAL TECHNOLOGY OPERATIONS LLC, Detroit, MI (US)

(21) Appl. No.: 13/215,533

(22) Filed: Aug. 23, 2011

(30) Foreign Application Priority Data
Aug. 24, 2010 (DE) 102010035201.2

(51) Int. Cl. G06K 19/00; G06K 19/07; G06K 19/06

(52) U.S. Cl. 235/492; 235/487; 235/494

(57) ABSTRACT

An information carrier is provided with information regarding a vehicle that can be directly arranged on the vehicle and the information of which is at least partially encrypted with a code that can be optoelectronically scanned and/or a code that can be scanned with the aid of electromagnetic waves. A vehicle, particularly a motor vehicle, with at least one such information carrier is also provided and a system is provided for assisting emergency services in rescuing occupants from a vehicle involved in an accident with a scanning device for scanning a code of an information carrier.

### CROSS-REFERENCE TO RELATED APPLICATION

This application claims priority to German Patent Application No. 102010035201.2, filed Aug. 24, 2010, which is incorporated herein by reference in its entirety.

### TECHNICAL FIELD

The technical field pertains to an information carrier with information regarding a vehicle. The technical field also pertains to a vehicle, particularly a motor vehicle, with at least one information carrier. The technical field furthermore pertains to a system for assisting emergency services in rescuing occupants from a vehicle involved in an accident.

### BACKGROUND

When a vehicle is involved in an accident, experience has shown that it is frequently very difficult for emergency services to quickly rescue the occupants located in the vehicle. In order to carry out a quick rescue, emergency services require information regarding the vehicle so as to define how the occupants are rescued. For example, emergency services require information on the structure of the vehicle in order to cut open the vehicle roof as quickly as possible. If the roof structure is at least partially made of high-strength steel, these high-strength material structures need to be accordingly taken into account in the cuts to be carried out. The manner, in which the occupants are rescued, is also affected, for example, by the number of airbags and their arrangement in the vehicle. Such vehicle-related information is not available to emergency services in many instances such that the rescue of occupants is very elaborate and frequently represents a race against time.

In recent years, vehicle manufacturers have started to prepare information carriers in the form of data cards, on which vehicle-related data for the individual vehicles or vehicle types is stored, in order to simplify the rescue of occupants for emergency services after an accident with the aid of this data. Due to the large number of different vehicle types and the variety of individual models that in the meantime exist within each vehicle type, however, the number of hardcopy data cards has become quite extensive and comprises a significant number of file folders. Consequently, valuable time is frequently lost until emergency services are able to locate the desired data sheet in the numerous file folders.

Therefore, at least one objective is an information carrier with the initially cited characteristics that makes it possible to quickly and easily provide emergency services with vehicle-related information in case of an accident. At least another objective is a vehicle, in which vehicle-related information can be quickly and easily determined. In addition, at least another objective is a system for assisting emergency services in rescuing occupants from a vehicle involved in an accident. In addition, other objectives, desirable features and characteristics will become apparent from the subsequent summary and detailed description, and the appended claims, taken in conjunction with the accompanying drawings and this background.

### SUMMARY

An information carrier contains information regarding a vehicle and can be permanently attached to the vehicle. In this way, essential and important information or data can be provided directly on the vehicle such that information on the vehicle can be made available to emergency services on-site. This significantly simplifies the rescue of occupants from a vehicle involved in an accident because it is no longer necessary to carry out a time-consuming search for the vehicle data corresponding to the respective vehicle in a large number of data sheets and file folders.

It is furthermore proposed that the information of the information carrier is at least partially encrypted with a code that can be optoelectronically scanned and/or a code that can be scanned with the aid of electromagnetic waves. In this way, the information regarding the vehicle can be compressed on an information carrier of particularly small dimensions that can be arranged on the vehicle such that is barely visible. The encrypted code furthermore makes it possible to store a large volume of information on the information carrier. The information carrier makes it possible for emergency services to decrypt the code at the site of an accident with the aid of a corresponding scanner and therefore to quickly obtain vehicle-related data. In this way, the rescue of occupants is significantly simplified.

According to an embodiment, it is proposed that the code is a barcode. Such barcodes are widely used such that inexpensive and mass-produced scanners available on the market can be used for decrypting the barcode.

According to another embodiment, it is proposed that the code is stored on a transponder in the form of a sensor. Due to this measure, the information carrier has a particularly compact design. The transponder may advantageously consist of an RFID-transponder. An RFID-system is based on identification with the aid of electromagnetic waves, wherein a high-frequency alternating electromagnetic field for generating an induction current in the transponder is preferably generated in the scanning device in order to read out the information. Due to this measure, visual contact between the scanning device and the information carrier is not required for reading out the information. Consequently, the information carrier can be arranged at predefined locations of the vehicle that are not visible from outside.

According to another embodiment, it is proposed that the code contains at least part of the vehicle identification number. The vehicle identification number or serial identification number was in the past also referred to as chassis plate number. The serial identification number or vehicle identification number makes it possible to access essential information on the vehicle that already assists emergency services in rescuing the occupants. In this way, the vehicle identification number furthermore is incorporated into the information carrier such that it is not necessary to provide another information carrier for carrying along the required vehicle identification number. The code should preferably contain information on the drive type of the vehicle. It would be conceivable that the code makes it possible to distinguish whether the vehicle features an internal combustion engine or an electric motor or the vehicle is a so-called hybrid vehicle with a combined electric and internal combustion drive.

It would also be possible that the code contains information on the fuel type of the vehicle. It would be conceivable that the code makes it possible to distinguish whether the vehicle is operated with gasoline, diesel, and natural gas or liquefied gas. In this way, the information contained in the code also makes it possible to determine whether the vehicle is a so-called CNG natural gas vehicle or a so-called LPG liquefied gas vehicle. In the context of the invention, CNG is the abbreviation for the English term “Compressed Natural Gas,” and LPG is the abbreviation for the English term “Low Pressure Gas.”

It would furthermore be possible that the code contains information on the at least one fuel line and/or the at least one electric line of the vehicle. Due to this measure, emergency services scanning the code at the site of an accident are already provided with information on the possibility of a life-threatening situation to be avoided. The code should preferably contain information on the position and/or routing of the at least one fuel line and/or the at least one electric line of the vehicle. If emergency services need to use the Jaws of Life during the rescue of the occupants, they are provided with decisive information for avoiding a situation hazardous to the occupants, as well as emergency services.

In vehicles with electric drives or in hybrid vehicles, information on the position or the routing of the at least one electric line is also particularly relevant because the electric line may have a high-voltage line and information on the routing of the high-voltage line therefore represents decisive information for emergency services. In order to largely avoid life-threatening situations for the occupants to be rescued and emergency services, the code should contain information on deactivating supply lines for operating equipment or other similar components and/or modules of the vehicle.

According to an embodiment, it is proposed that the code has the vehicle identification number and at least one additional number. Due to this measure, the standardized vehicle identification number is utilized and the information on the vehicle contained therein can be used. The at least one additional number makes it possible to provide further information by means of the code. For example, the fuel type can be encrypted with the magnitude of the number. The drive type of the vehicle can be additionally or alternatively encrypted with the number. It would therefore be conceivable to use the number for realizing the following encryption:

| Number | Code information |
|---|---|
| 1 | Gasoline |
| 3 | Diesel |
| 5 | Natural gas |
| 7 | CNG natural gas |
| 9 | Liquefied gas |
| 0 | Electric drive |

It would also be conceivable to encrypt two numbers in addition to the vehicle identification number. For example, the fuel number may be combined with the number zero, by means of which a hybrid drive may be encrypted.

According to another embodiment, it is proposed that information regarding the vehicle is encrypted with the code in combination with at least one symbol that can be read without technical implements. Due to this measure, the information carrier contains at least two codes, wherein one of these codes can be read without technical implements. This code that can be scanned without technical implements may have, for example, of at least one number and/or at least one letter. It would also be conceivable that the information regarding the vehicle is contained on the information carrier in the form of the at least one symbol that can be read without technical implements.

Due to the at least one additional symbol contained on the information carrier, emergency services can obtain vehicle-related information that is required, e.g., for the rescue of occupants by means of the data sheets. It is therefore prevented that emergency services need to carry out a rescue operation without any information on the vehicle, for example, if a scanner for the code that can be optoelectronically scanned or the code that can be scanned with the aid of electromagnetic waves is not carried along or defective, respectively. The at least one symbol that can be read without technical implements may contain information on the drive type or the fuel type.

One possible embodiment may provide two symbols that can be read without technical implements, where one symbol indicates the fuel type and the other symbol makes it possible to determine whether the vehicle features a hybrid drive. If the symbol is a number, it would be possible, for example, to encrypt an electric drive with the number zero and a fuel type in the form of gasoline with the number 1. In this case, the number combination or the number code 0 and 1 would indicate a hybrid drive consisting of an electric motor in combination with a gasoline-operated internal combustion engine.

A vehicle, particularly a motor vehicle, is provided with at least one information carrier of the above-described type. The information carrier may be rigidly arranged on the vehicle, particularly in a durable fashion. This ensures that the information carrier also remains attached to the vehicle in case of an accident, particularly an accident involving significant damage to the vehicle. The information carrier preferably should be connected to the vehicle by means of integral joining methods such as, for example, welding, soldering and/or bonding.

It would alternatively also be possible to integrate the information carrier into the vehicle. In this case, the information carrier or the code of the information carrier may be integrated into the vehicle, for example, by means of engraving. The at least one information carrier may furthermore be visibly or invisibly arranged on a door opening, the hood frame, a window frame, the frame or the trunk opening of the vehicle. In this way, the information carrier is arranged at locations that are easily accessible or easily visible to emergency services from outside.

Several information carriers may be provided and arranged on the vehicle in a distributed fashion. In an accident involving significant damage to the vehicle, this ensures that information carriers remain on the vehicle and can be read by emergency services despite the deformation of the vehicle.

A system is also provided for assisting emergency services in rescuing occupants from a vehicle involved in an accident with a scanning device for scanning a code on an information carrier of the above-described type. The system enables emergency services to easily and directly read out the encrypted information contained on the information carrier by means of the scanning device such that the required information is quickly obtained and available for at least an initial assessment. The rescue of the occupants is significantly simplified in this fashion.

According to an embodiment, it is proposed that the scanning device is or can be coupled to a communication device, by means of which information associated with the scanned code of the information carrier can be obtained from a knowledge base. This makes it possible to access for more information than that stored on the information carrier based on the code scanned on the information carrier.

The knowledge base may be a database that is stored on a storage medium, preferably a Personal Computer or Notebook of the emergency services. It would also be conceivable to query the knowledge base remotely, for example, via the Internet or telephone or radio, such that emergency services do not have to carry along the complicated and susceptible technology of a notebook or the like.

The knowledge base may be realized in the form of an Internet platform accessible to emergency services. In this case, the query of the relevant information may be based on the identification number of the respective vehicle that is known to the manufacturers for all models. In this way, emergency services merely need to scan the vehicle identification number on the information carrier by means of corresponding scanning devices in order to obtain additional information relevant to the rescue of the occupants from the Internet platform.

The information that can be obtained by means of the information carrier or from the knowledge base may indicate the area, at which the vehicle columns need to be respectively cut open or severed. Information on the position of the battery, the number and position of airbags, the position of the fuel tank and the type of fuel, on which the vehicle operates, can also be very quickly obtained or retrieved, respectively.

In case of a traffic accident, at least an initial assessment is available without significant delay. The information on the vehicle is quickly available and provides emergency services with decisive information, for example, of the location, at which the vehicle roof needs to be severed or the battery and the airbags are located within the vehicle. Emergency services therefore are able to act quickly, wherein this may, if applicable, be the decisive factor with respect to the survival or the death of the occupants.

### BRIEF DESCRIPTION OF THE DRAWINGS

The present invention will hereinafter be described in conjunction with the following drawing figures, wherein like numerals denote like elements, and:

FIG. 1 shows an enlarged representation of one possible embodiment of an information carrier with information on the vehicle, as well as a perspective representation of a vehicle with several information carriers arranged thereon; and

FIG. 2 shows another perspective representation of the vehicle according to FIG. 1 with an indication of several locations, at which the information carrier according to FIG. 1 is arranged on the vehicle.

### DETAILED DESCRIPTION

The following detailed description is merely exemplary in nature and is not intended to limit application and uses. Furthermore, there is no intention to be bound by any theory presented in the preceding background or summary or the following detailed description.

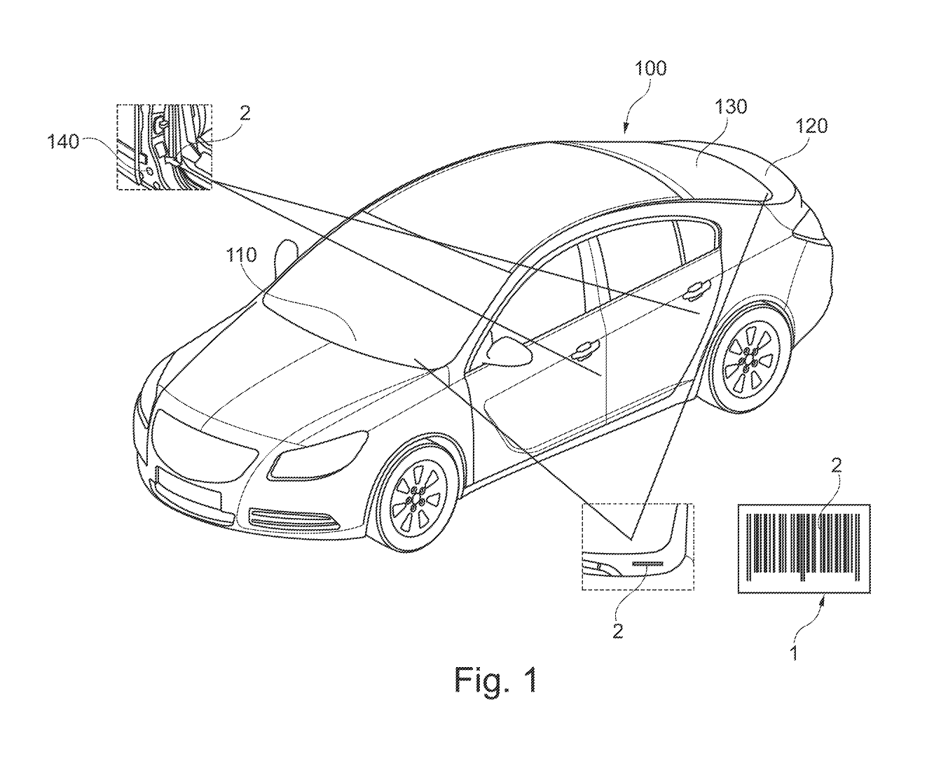

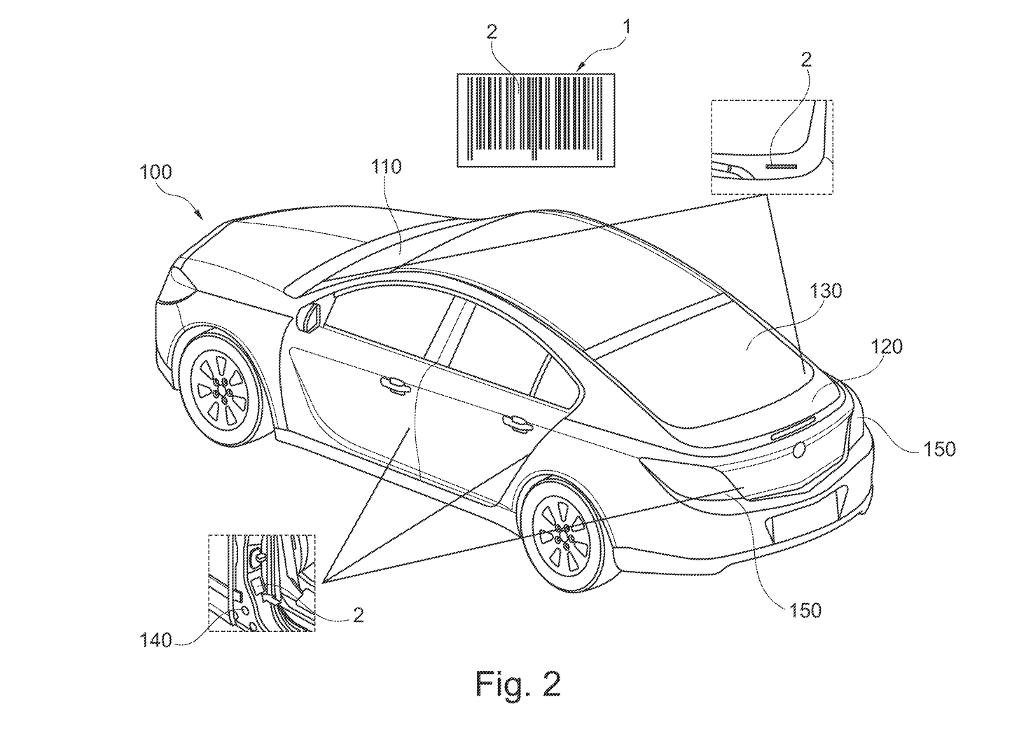

FIG. 1 and FIG. 2 show an information carrier 1 that contains information on the vehicle 100 illustrated in FIGS. 1 and FIG. 2, the enlarged information carrier 1 illustrated in FIGS. 1 and 2 is encrypted with a barcode 2. According to FIG. 1, the information carrier 1 may be arranged at different locations of the vehicle 100. The information carrier 1 with its barcode 2 may be arranged on the front windshield 110 of the vehicle 100, e.g., in the region of the rain runoff channel. The information carrier 1 may also be arranged on the trunk lid 120, particularly on the rear window 130. It would furthermore be conceivable to arrange the information carrier 1 on the vehicle columns 140.

The information carrier 1 preferably is arranged on the vehicle 100 at all of the aforementioned locations. The locations for arranging the information carrier 1 on the vehicle 100 are also illustrated in FIG. 2. FIG. 2 furthermore shows that the information carrier 1 may also be arranged in the area between the taillights 150.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An apparatus comprising:
an information carrier configured to carry information regarding a vehicle;
an attachment mechanism configured to durably attached the information carrier to the vehicle,
wherein the information regarding the vehicle is at least partially encrypted with a scanable code.

2. The apparatus according to claim 1, wherein the scanable code is optoelectronically scanable.

3. The apparatus according to claim 1, wherein the scanable code is scanable with an aid of electromagnetic waves.

4. The apparatus according to claim 1, wherein the scanable code is a barcode.

5. The apparatus according to claim 1, further comprising a transponder configured to store the scanable code

6. The apparatus according to claim 5, wherein the transponder is an RFID-transponder.

7. The apparatus according to claim 1, wherein the scanable code comprises at least part of an identification number of the vehicle.

8. The apparatus according to claim 1, wherein the scanable code comprises at least a drive type of the vehicle.

9. The apparatus according to claim 1, wherein the scanable code comprises a fuel type of the vehicle.

10. The apparatus according to claim 1, wherein the scanable code comprises at least a position of a fuel line of the vehicle.

11. The apparatus according to claim 1, wherein the scanable code comprises at least a routing of an electric line of the vehicle.

12. The apparatus according to claim 1, wherein the scanable code comprises deactivating information for a component of the vehicle.

13. The apparatus according to claim 1, wherein the scanable code comprises an identification number of the vehicle and at least one additional number.

14. The apparatus according to claim 1, wherein the information regarding the vehicle is encrypted with the scanable code in combination with at least one symbol that is readable without technical implements.

15. The apparatus according to claim 1, wherein the attachment mechanism is rigidly arranged on the vehicle

16. The apparatus according to claim 1, wherein the attachment mechanism connects to the vehicle with an integral joint.

17. The apparatus according to claim 1, wherein the information carrier is visibly arranged on a door opening.

18. The apparatus according to claim 1, wherein the information carrier is invisibly arranged on a hood frame.
